(19) United States
(12) Patent Application Publication
(10) Pub. No.: US 2008/0283534 A1
(43) Pub. Date: Nov. 20, 2008

(54) Medical supply container and medical supply kit

(76) Inventor: Anna J. Paz, Charlestown, MA (US)

Correspondence Address: JAMES RAY & ASSOCIATES, 2640 Pitcairn Road, Monroeville, PA, 15146, US

(21) Appl. No.: 12/152,317

(22) Filed: May 14, 2008

Related U.S. Application Data
(60) Provisional application No. 60/938,198, filed on May 16, 2007.

(51) Int. Cl. A61J 1/00; B65D 25/20; B65D 25/04

(52) U.S. Cl. 220/528; 206/438; 220/737

(57) ABSTRACT

A medical supply container includes a generally hollow first member, manufactured from a first predetermined material and having a first predetermined size and a first predetermined shape, for housing at least one of medical supplies and medical waste therein. A securing mechanism is operably connected to such container at a first predetermined location thereon for releasably attaching such container to at least one of a rod and a pole.

### CROSS REFERENCE TO RELATED APPLICATION

This patent application is related to and claims priority from U.S. Provisional Patent Application Ser. No. 60/938,198 filed May 16, 2007.

### FIELD OF THE INVENTION

The present invention relates, in general, to devices for use in administering IV infusions, and more particularly, this invention relates to a medical supply container for housing at least one of medical supplies, such as those used during an IV infusion, and medical waste, such as used medical supplies from an IV infusion. Such medical supply container can be attached to a pole or rod such as an IV pole or rod. Furthermore, this invention relates to a medical supply kit which can be attached to a pole.

### BACKGROUND OF THE INVENTION

Prior to the conception and development of the present invention, intravenous infusions or “IV” infusions (“IV”s), as are generally well known in the prior art, have been used to treat patients who need fluids injected directly into their veins. A fluid bag is generally hung on an IV pole with tubing leading to an injection site where fluid enters into a patient's circulatory system. Such IV pole is movable with the patient. Unfortunately, there currently exists no device or kit for containing necessary IV supplies and which is attachable to an IV pole for use with an IV infusion and disposing of IV infusion waste materials.

Specifically of interest to the present invention are the following: Orr, U.S. Pat. No. 3,820,656, discloses a compartmented container which includes an elongated container forming a back or base and having second and third compartments spaced in relation with clamp means there between and secured to the elongated container for supporting the container arrangement on a rod or pole. The container does not include means for securing items stored within the compartments to safeguard them from loss or contamination and does not includes items specifically for administering IV infusions and disposing of IV infusion waste materials.

Pick, U.S. Pat. No. 4,170,300 discloses a kit for aseptic changing of a dressing which includes a disposable tray having a cover sheet adhering thereto and closing depressions in the tray. The cover sheet is removable from the tray so as to render the depressions thereof accessible. In the depressions are items such as packet's of antiseptic germicide solution and ointment, cleansing swabs, swab sticks, gauze pads, and adherent tape. There also may be a sheet of drape material, a plastic bag for receiving a previously applied dressing which is removed, and plastic gloves. One of the items included in the tray is a suitable cutting tool, such as a disposable scissors. Such a tray style container would likely need to be flat for ease of opening and in order to prevent items from falling out during use therefore limiting its practicality and convenience. Additionally, the tray is not attachable to pole such as an IV pole.

Withers, U.S. Pat. No. 5,752,234 discloses a method of supplying health care workers with disposable supplies appropriate for a single patient visit. The disposable supplies are placed in a disposable container, which is delivered to a first site where a patient is to receive treatment prior to the visit by the health care worker. The container is subsequently delivered to a second site for disposal after the visit. A package for use by a health care worker in performing health care services comprises a disposable container adapted to receive disposable supplies.

Kozimor, et al, U.S. Pat. No. 6,231,936 discloses articles such as packaging materials and medical devices having enhanced tolerance to radiation and heat, produced from a blend of from about 99% to about 50% by weight homo or copolymerized polypropylene and about 1% to about 50% by weight polyethylene produced by single-site catalysis, such polyethylene having a MWD between about 1 and about 4, and a CDBI greater than about 45%. Also provided are processes for producing such articles.

### SUMMARY OF THE INVENTION

The present invention provides a medical supply container including a generally hollow first member, manufactured from a first predetermined material and having a first predetermined size and a first predetermined shape, for housing at least one of medical supplies and medical waste therein. A securing mechanism is operably connected to such container at a first predetermined location thereon for releasably attaching such container to at least one of a rod and a pole.

According to another embodiment, a medical supply kit is provided. Such medical supply kit includes a container, being manufactured from a predetermined material and having a predetermined size and a predetermined shape, such container including a generally hollow first member for at least one of housing medical supplies therein and receiving and storing medical waste therein. A securing means is operably connected to the container at a first predetermined location thereon for releasably attaching the container to at least one of a rod and a pole. A plurality of predetermined medical supplies are housed within such first member.

### OBJECTS OF THE INVENTION

It is, therefore, one of the primary objects of the present invention to provide a container which is attachable to an IV pole and which can be used for carrying medical supplies and for receiving and storing medical waste.

Yet another object of the present invention is to provide a disposable container which is attachable to an IV pole and which can be used for carrying medical supplies and waste.

Still another object of the present invention is to provide a medical supply kit which contains items necessary for administering an IV infusion or the like.

Another object of the present invention is to provide a medical supply kit which is attachable to a pole or rod.

Yet another object of the present invention is to provide a medical supply kit which includes a container having hollow members, such container being attachable to a pole or rod and being for containing medical supplies therein and for receiving and storing medical waste such as used gauze, scraps of medical tape, and the like.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention.

FIG. 2 is a partial perspective view of the invention according to one embodiment of the invention.

FIG. 3 is a partial perspective side view of the invention according to one embodiment of the invention.

FIG. 4 is a partial perspective view of the invention according to one embodiment of the invention.

FIG. 5 is a partial perspective view of the invention according to one embodiment of the invention.

FIG. 6 is a partial perspective view of the invention according to one embodiment of the invention.

FIG. 7 is a partial perspective side view of the invention according to one embodiment of the invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

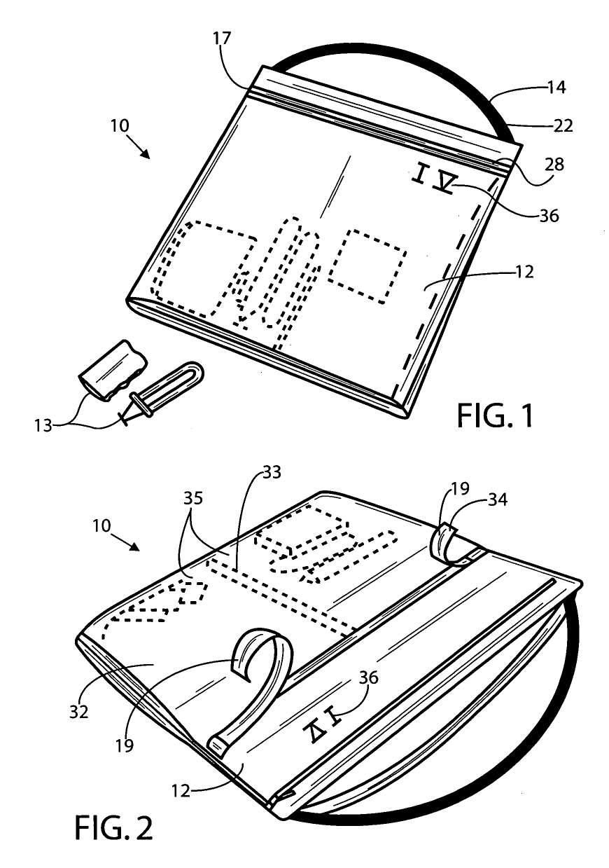

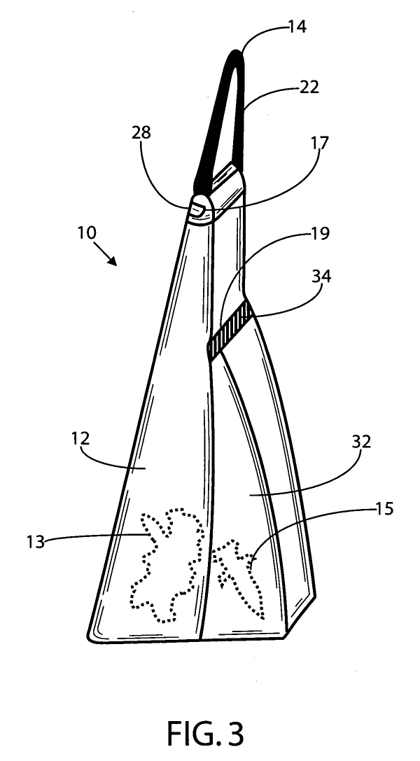

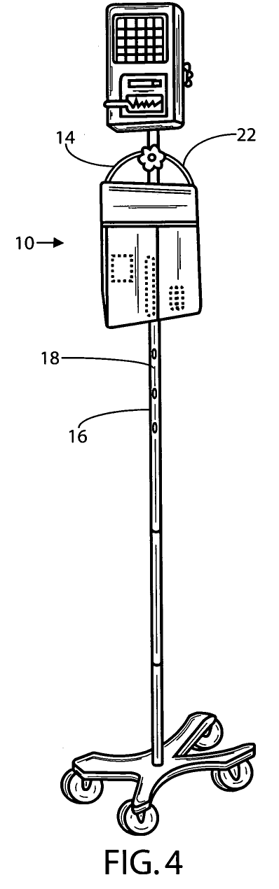

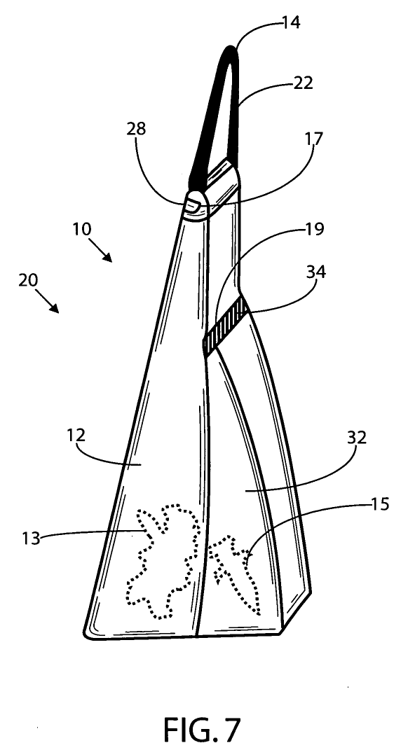

Reference is now made, more particularly, to FIGS. 1-7.

Referring to FIGS. 1-4, a medical supply container, generally designated 10, is provided. Such medical supply container 10 includes a generally hollow first member 12, manufactured from a first predetermined material and having a first predetermined size and a first predetermined shape, for housing at least one of medical supplies 13 and medical waste 15 therein. It is presently preferred that such first member 12 is between about 11.0 inches by about 11.0 inches.

It is presently preferred that such first predetermined material is plastic. It is further presently preferred that such plastic is transparent. It is further presently preferred that such medical supply container is disposable.

A securing means 14 is operably connected to the container 10 at a first predetermined location thereon for releasably attaching the container 10 to at least one of a rod 16 and a pole 18. It is presently preferred that such securing means 14 is a handle type securing means 22. However, such securing means 14 is not meant to be limited to a handle type securing means 22 and may be any type securing means which will facilitate securing such container 10 to such at least one of such rod 16 and such pole 18. Other types of securing means contemplated include hook and loop type fasteners and adhesive type fasteners.

It is presently preferred that such at least one rod 16 and pole 18 are the types of rods and poles upon which fluid bags such as IV fluid bags are hung. Generally such IV poles have various portions upon which such handle type securing means 22 may be releasably attached, for example a hook, an adjustment knob, and the like.

It is presently preferred that such first member 12 includes a first fastening means 28 operably connected thereto at a first predetermined location thereon for releasably fastening such first member 12 in a closed position such that such at least one of such medical supplies 13 and such medical waste 15 are secured therein.

It is presently preferred that such first fastening means 28 is at least one of an adhesive type fastening means, hook and loop type fastening means, and a tongue in groove type fastening means. It is further presently preferred that such first fastening means is a tongue in groove type fastening means 17.

It is presently preferred that such container 10 further includes a generally hollow second member 32 manufactured from a second predetermined material and having a second predetermined size and a second predetermined shape and being operably connected to the first member 12 at a second predetermined location thereon, such second member 32 being for housing at least one of medical supplies 13 and medical waste 15 therein. It is presently preferred that such second member 32 is between about 11.0 inches by about 7.0 inches.

It is presently preferred that such second member 32 further includes a dividing means 33 operably connected thereto at a predetermined location thereon for dividing such second member 32 into a plurality of compartments 35. Such first member 12 may also include a dividing means for dividing such first member 12 into a plurality of compartments if desired.

It is presently preferred that such second member 32 includes a second fastening means 34 operably connected thereto at a predetermined location thereon for releasably fastening such second member 32 in a closed position.

It is presently preferred that such second fastening means 34 is at least one of an adhesive type fastening means, hook and loop type fastening means, and a tongue in groove type fastening means. It is presently most preferred that such second fastening means is an adhesive type fastening means 19. Such fastening means may be a resealable adhesive type fastening means or may include a convenient pull tab type adhesive fastening.

It is presently preferred that at least one of such first member 12 and such second member 32 has predetermined indicia 36 disposed thereon at a predetermined location. It is further presently preferred that such predetermined indicia 36 includes at least one of symbols, letters, words, pictoral designs, and a combination thereof.

It is presently preferred that such medical supply container 10 is disposable.

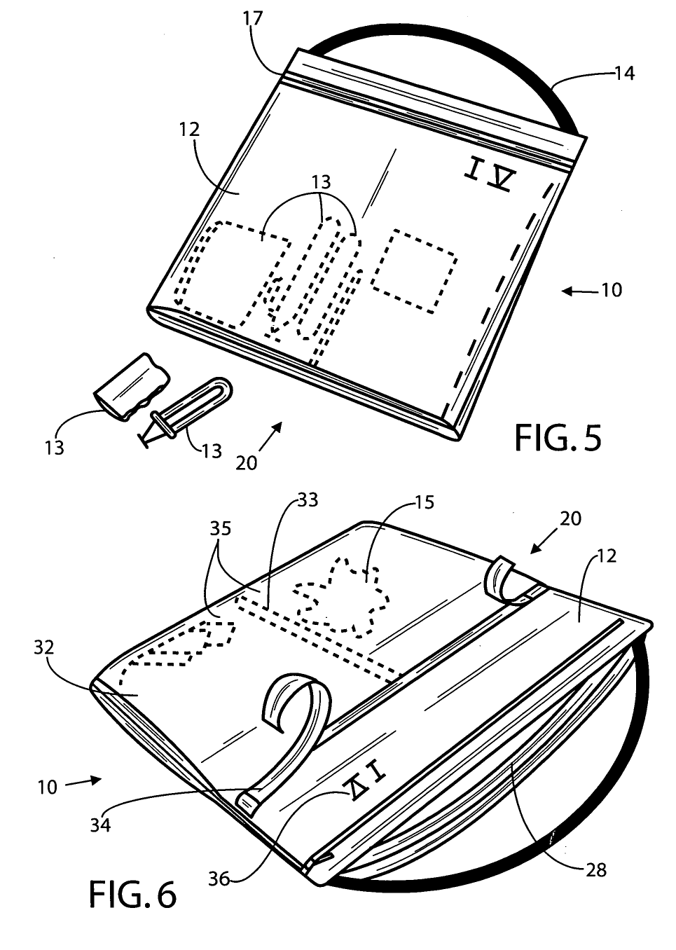

Referring to FIGS. 5-7, according to another embodiment, a medical supply kit, generally designated 20, is provided. Such medical supply kit 20 includes a container, generally designated 10, being manufactured from a predetermined material and having a predetermined size and a predetermined shape. Such container 10 includes a generally hollow first member 12 for at least one of housing medical supplies 13 therein and receiving and storing medical waste 15 therein.

A securing means 14 is operably connected to such container 10 at a first predetermined location thereon for releasably attaching such container 10 to at least one of a rod 16 and a pole 18. A plurality of predetermined medical supplies 13 are housed within the first portion 12 of such container 10.

It is presently preferred that such predetermined medical supplies 13 include at least one of a pair of disposable gloves, alcohol prep pads, gauze sponges, sterile gauze, transparent tape, saline flush, and a combination thereof.

It is presently preferred that such container 10 is disposable.

It is presently preferred that such container 10 further includes a generally hollow second member 32 operably connected to such first member 12 at a first predetermined location thereon, such second member 32 being for at least one of housing such plurality of predetermined medical supplies 13 therein and receiving and storing predetermined medical waste 15 therein.

It is presently preferred that such second member 32 further includes a dividing means 33 operably connected thereto at a predetermined location thereon for dividing such second member 32 into a plurality of compartments 35. Such first member 12 may also include a dividing means for dividing such first member 12 into a plurality of compartments if desired.

It is presently preferred that such first member 12 includes a first fastening means 28 operably connected thereto at a second predetermined location thereon for releasably fastening such first member 12 in a closed position such that the medical supplies 13 are secured therein. It is presently preferred that such first fastening means 28 is at least one of an adhesive type fastening means, hook and loop type fastening means, and a tongue in groove type fastening means.

It is presently preferred that such second member 32 includes a second fastening means 34 operably connected thereto at a predetermined location thereon for releasably fastening such second member 32 in a closed position. It is presently preferred that such second fastening means 34 is at least one of an adhesive type fastening means, hook and loop type fastening means, and a tongue in groove type fastening means.

It is presently preferred that at least one of such first member 12 and such second member 32 has predetermined indicia 36 disposed thereon at a predetermined location. It is further presently preferred that such predetermined indicia 36 includes at least one of symbols, letters, words, pictoral designs, and a combination thereof.

It is presently preferred that such medical supply kit 20 is disposable.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A medical supply container comprising:
a. a generally hollow first member, manufactured from a first predetermined material and having a first predetermined size and a first predetermined shape, for housing at least one of medical supplies and medical waste therein; and
b. a securing means operably connected to said container at a first predetermined location thereon for releasably attaching said container to at least one of a rod and a pole.

2. A medical supply container according to claim 1 wherein said first member includes a first fastening means operably connected thereto at a first predetermined location thereon for releasably fastening said first member in a closed position such that such at least one of such medical supplies and such medical waste are secured therein.

3. A medical supply container according to claim 2 wherein said first fastening means is at least one of an adhesive type fastening means, hook and loop type fastening means, and a tongue in groove type fastening means.

4. A medical supply container according to claim 3 wherein said first fastening means is a tongue and groove type fastening means.

5. A medical supply container according to claim 1 wherein said first predetermined material is plastic.

6. A medical supply container according to claim 5 wherein said plastic is transparent.

7. A medical supply container according to claim 1 wherein said container further includes a generally hollow second member manufactured from a second predetermined material and having a second predetermined size and a second predetermined shape and being operably connected to said first member at a second predetermined location thereon, said second member being for housing at least one of medical supplies and medical waste therein.

8. A medical supply container according to claim 7 wherein said second member includes a second fastening means operably connected thereto at a predetermined location thereon for releasably fastening said second member in a closed position.

9. A medical supply container according to claim 8 wherein said second fastening means is at least one of an adhesive type fastening means, hook and loop type fastening means, and a tongue in groove type fastening means.

10. A medical supply container according to claim 9 wherein said second fastening means is an adhesive type fastening means.

11. A medical supply container according to claim 7 wherein said first member is between about 11.0 inches by about 11.0 inches.

12. A medical supply container according to claim 7 wherein said second member is between about 11.0 inches by about 7.0 inches.

13. A medical supply container according to claim 1 wherein said securing means is a handle type securing means.

14. A medical supply container according to claim 7 wherein said second member further includes a dividing means operably connected thereto at a predetermined location thereon for dividing said second member into a plurality of compartments.

15. A medical supply kit comprising:
a. a container, being manufactured from a predetermined material and having a predetermined size and a predetermined shape, and including a generally hollow first member for at least one of housing predetermined medical supplies therein and receiving and storing medical waste therein;
b. a securing means operably connected to said container at a first predetermined location thereon for releasably attaching said container to at least one of a rod and a pole; and
c. a plurality of predetermined medical supplies, said predetermined medical supplies being housed within said first member.

16. A medical supply kit according to claim 15 wherein said predetermined medical supplies include at least one of a pair of disposable gloves, alcohol prep pads, gauze sponges, sterile gauze, transparent tape, saline flush, and a combination thereof.

17. A medical supply kit according to claim 15 wherein said container further includes a generally hollow second member operably connected to said first member at a first predetermined location thereon, said second member being for at least one of housing said plurality of predetermined medical supplies therein and receiving and storing predetermined medical waste therein.

18. A medical supply kit according to claim 15 wherein said first member includes a first fastening means operably connected thereto at a second predetermined location thereon for releasably fastening said first member in a closed position such that said predetermined medical supplies are secured therein.

19. A medical supply kit according to claim 15 wherein said second member includes a second fastening means operably connected thereto at a predetermined location thereon for releasably fastening said second member in a closed position.

20. A medical supply kit according to claim 15 wherein said second member further includes a dividing means operably connected thereto at a predetermined location thereon for dividing said second member into a plurality of compartments.
